(19) United States
(12) Patent Application Publication
(10) Pub. No.: US 2025/0307298 A1
(43) Pub. Date: Oct. 2, 2025

(54) INFORMATION PROCESSING SYSTEM, INFORMATION PROCESSING METHOD, AND COMPUTER READABLE STORAGE MEDIUM

(71) Applicant: RAKUTEN GROUP, INC., Tokyo (JP)

(72) Inventors: Tanapat Ratanaruengjumrune, Tokyo (JP); Kunal Ghanashyam Thakre, Bangalore (IN); Ning LI, Tokyo (JP)

(21) Appl. No.: 19/078,190

(22) Filed: Mar. 12, 2025

(30) Foreign Application Priority Data
Mar. 26, 2024 (JP) 2024-049445

(51) Int. Cl. G06F 16/35; G06F 40/279

(52) U.S. Cl. CPC G06F 16/35; G06F 40/279

(57) ABSTRACT

An information processing system configured to: classify, based on an attribute value of each of a plurality of types of attributes stored in association with each of a plurality of users, the plurality of users into a plurality of clusters; calculate, for each of a plurality of users classified into a target cluster being any one of the plurality of clusters, a contribution degree of each of the plurality of types of attributes to classify into the target cluster; calculate, based on the attribute value of each of the plurality of types of attributes stored in association with each of the plurality of users classified into the target cluster, a representative attribute value that represents the target cluster for the type of attribute; and output, based on the representative attribute value and the contribution degree, information indicating a representative personality of a user belonging to the target cluster.

### CROSS-REFERENCE TO RELATED APPLICATION

The present application claims priority from Japanese application JP2024-049445 filed on Mar. 26, 2024, the content of which is hereby incorporated by reference into this application.

### BACKGROUND

### 1. Field of the Disclosure

The present invention relates to an information processing system, an information processing method, and a computer readable storage medium.

### 2. Description of the Related Art

There has been a system which uses big data on users to analyze representative personality of a group formed of a plurality of users who satisfy a given condition.
[Non Patent Literature 1] LY Corporation. “Persona—DS. INSIGHT,” [online], [Referenced on Feb. 28, 2024], Internet <https://ds.yahoo.co.jp/service/insight/persona.html>
[Non Patent Literature 2] J. A. Pardo, “AI-powered Personas: Bringing Personas to life through LLMs,” [online], [Referenced on Feb. 28, 2024], Internet <https://medium.com/@josetecangas/ai-powered-personas-bringing-personas-to-life-through-11ms-d1246da02858>

Hitherto, grouping of users and analysis of personality of the users belonging to each group have relied on the intuition of a data scientist. Thus, it is difficult, for example, to classify the group by an unknown classification method, or to find out, from various attributes, an attribute which characterizes a group. Moreover, there has been a limit on precision of the analysis.

### SUMMARY

An object of the present disclosure is to provide a technology which more easily and highly precisely outputs representative personality of a group of users.
(1) There is provided an information processing system including: classification means for classifying, based on an attribute value of each of a plurality of types of attributes stored in association with each of a plurality of users, the plurality of users into a plurality of clusters; contribution calculation means for calculating, for each of a plurality of users classified into a target cluster being any one of the plurality of clusters, a contribution degree of each of the plurality of types of attributes to classify into the target cluster; representative acquisition means for acquiring, based on the attribute value of each of the plurality of types of attributes stored in association with each of the plurality of users classified into the target cluster, a representative attribute value that represents the target cluster corresponding to one of the plurality of types of attributes; and output means for outputting, based on the representative attribute value and the contribution degree, information indicating a representative personality of a user belonging to the target cluster.
(2) The information processing system according to Item (1) further includes training means for training a machine learning model through use of training data including the attribute value of each of the plurality of types of attributes in each of the plurality of users and ground truth data indicating a cluster into which each of the plurality of users is classified, and the contribution calculation means is configured to calculate the contribution degree of each of the plurality of types of attributes to the classification into the target cluster for each of the plurality of users classified into the target cluster based on the trained machine learning model and the attribute values of the plurality of types of attributes in each of the plurality of users classified into the target cluster.
(3) The information processing system according to Item (1) or (2) further includes importance calculation means for calculating an importance degree for the classification of the plurality of users into the target cluster for each of the plurality of types of attributes based on the contribution degrees calculated for the plurality of users classified into the target cluster, and the output means is configured to output, based on the representative attribute value and the importance degree, the information indicating the representative personality of a user belonging to the target cluster.
(4) The information processing system according to Item (3) further includes attribute selection means for selecting some of the plurality of types of attributes based on the importance degree, and the output means is configured to output, based on the representative attribute values in the selected some of the plurality of types of attributes, the information indicating the representative personality of a user belonging to the target cluster.
(5) In the information processing system according to Item (3) or (4), the importance calculation means is configured to calculate, as the importance degree, an average value of the contribution degrees calculated for the plurality of users classified into the target cluster for each of the plurality of types of attributes.
(6) In the information processing system according to Item (3) or (4), the importance degree calculation means is configured to calculate, as the importance degree, a value indicating a correlation based on the contribution degrees and the attribute values in the plurality of users classified into the target cluster for each of the plurality of types of attributes.
(7) In the information processing system according to Item (3) or (6), the representative acquisition means is configured to: calculate an average value of the contribution degrees calculated for the plurality of users for each of the plurality of types of attributes; select some of the plurality of users as one or more representative users based on the average value and the contribution degrees of the plurality of users classified into the target cluster in each of at least some of the plurality of types of attributes; and generate a representative attribute value that represents the target cluster based on the attribute value in the one or more representative users for the at least some of the plurality of types of attributes.
(8) In the information processing system according to any one of Items (1) to (7), the representative acquisition means is configured to acquire a relative value that indicates a relative relationship between each of the representative attribute values calculated for the plurality of types of attributes and an overall representative attribute value calculated for a group formed of the plurality of clusters, and the output means is configured to output the information indicating the representative personality of a user belonging to the target cluster based on the contribution degree, the acquired relative value, and the representative attribute value.
(9) In the information processing system according to Item (8), the representative acquisition means is configured to acquire, for an attribute that indicates a category out of the plurality of types of attributes, a relative value indicating a probability that a plurality of users classified into the plurality of clusters belong to a category indicated by the representative attribute value of the target cluster.
(10) In the information processing system according to Item (8) or (9), the output means is configured to output the information indicating the representative personality of a user belonging to the target cluster based on the representative attribute value in an attribute selected from the plurality of types of attributes based on the contribution degree and the acquired relative value.
(11) In the information processing system according to any one of Items (1) to (10), the output means is configured to input, to a language model, a direction that includes the representative attribute values of at least some of the plurality of types of attributes for the target cluster and that causes the language model to generate a sentence indicating personality, and output the information indicating the representative personality of a user belonging to the target cluster based on output of the language model for the input.
(12) The information processing system according to Item (11) further includes attribute selection means for selecting some of the plurality of types of attributes based on the contribution degree, and the output means is configured to input, to a language model, a direction that includes the representative attribute values of the selected some of the plurality of types of attributes and that causes the language model to generate a sentence indicating personality, and output the information indicating the representative personality of a user belonging to the target cluster based on output of the language model for the input.
(13) In the information processing system according to any one of Items (8) to (10), the output means is configured to input, to a language model, a direction that includes the relative values of at least some of the plurality of types of attributes for the target cluster and that causes the language model to generate a sentence indicating personality, and output the information indicating the representative personality of a user belonging to the target cluster based on output of the language model for the input.
(14) In the information processing system according to any one of Items (1) to (13), the output means is configured to: input, to a language model, a direction that is based on the representative attribute value and the contribution degree and that causes the language model to generate a sentence for generating an image indicating personality; and input, to an image generation model, a generation direction for an image based on output of the language model for the input, and output, as the information indicating the representative personality of a user belonging to the target cluster, the information including the image that is output from the image generation model.
(15) There is provided an information processing method including: classifying, based on an attribute value of each of a plurality of types of attributes stored in association with each of a plurality of users, the plurality of users into a plurality of clusters; calculating, for each of a plurality of users classified into a target cluster being any one of the plurality of clusters, a contribution degree of each of the plurality of types of attributes to classify into the target cluster; acquiring, based on the attribute value of each of the plurality of types of attributes stored in association with each of the plurality of users classified into the target cluster, a representative attribute value that represents the target cluster corresponding to one of the plurality of types of attributes; and outputting, based on the representative attribute value and the contribution degree, information indicating a representative personality of a user belonging to the target cluster.
(16) There is provided a program for causing a computer to function as: classification means for classifying, based on an attribute value of each of a plurality of types of attributes stored in association with each of a plurality of users, the plurality of users into a plurality of clusters; contribution degree calculation means for calculating, for each of a plurality of users classified into a target cluster being any one of the plurality of clusters, a contribution degree of each of the plurality of types of attributes to classify into the target cluster; representative acquisition means for acquiring, based on the attribute value of each of the plurality of types of attributes stored in association with each of the plurality of users classified into the target cluster, a representative attribute value that represents the target cluster corresponding to one of the plurality of types of attributes; and output means for outputting, based on the representative attribute value and the contribution degree, information indicating a representative personality of a user belonging to the target cluster.

According to the at least one embodiment of the present invention, it is possible to more easily and accurately output the representative personality of the group of users.

### BRIEF DESCRIPTION OF THE DRAWINGS

FIG. 1 is a diagram for illustrating an example of elements relating to an information processing system according to at least one embodiment of the present invention.

FIG. 2 is a block diagram for illustrating functions implemented by the information processing system.

FIG. 3 is a table for showing an example of data stored in an attribute database.

FIG. 4 is a flowchart for schematically illustrating processing of the information processing system.

FIG. 5 is a table for showing an example of a result of clustering.

FIG. 6 is a table for showing an example of calculated contribution degrees.

FIG. 7 is a flowchart for illustrating an example of processing of a cluster attribute determination module.

FIG. 8 is a flowchart for illustrating an example of processing of calculating representative attribute values and index.

FIG. 9 is a view for illustrating an example of calculated representative attribute values and index values.

FIG. 10 is a flowchart for illustrating another example of the processing of the cluster attribute determination module.

FIG. 11 is a flowchart for illustrating an example of processing of a personality output module.

FIG. 12 is a view for illustrating an example of a first instruction text.

FIG. 13 is a view for illustrating an example of a description sentence generated based on the first instruction text.

FIG. 14 is a view for illustrating an example of a second instruction text.

FIG. 15 is a view for illustrating an example of a direction sentence generated based on the second instruction text.

### DETAILED DESCRIPTION

Now, at least one embodiment of the present invention is described with reference to the drawings. Redundant description of components denoted by the same reference symbols is omitted.

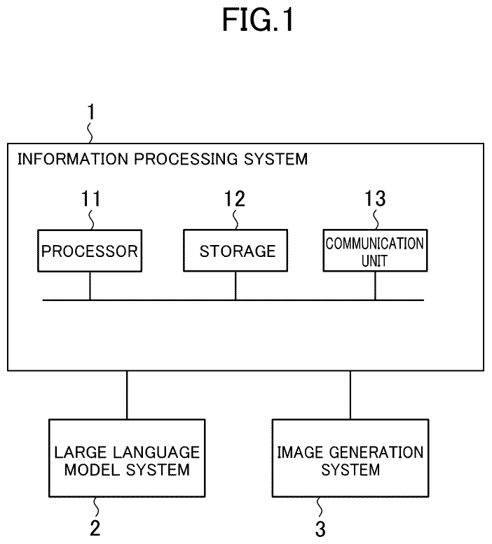

FIG. 1 is a diagram for illustrating an example of elements relating to an information processing system 1 according to the at least one embodiment of the present invention. The information processing system 1 acquires, based in a direction of an administrator, attribute information on a plurality of users, and classifies the plurality of users into a plurality of clusters. The information processing system 1 uses a large language model system 2 and an image generation system 3 to acquire information which describes personality of a representative user of the cluster, and outputs this information to the administrator. The administrator may operate an input/output device included in the information processing system 1 to execute the direction and reception of the output, or may execute the direction and the reception of the output via a computer (not shown) communicable to and from the information processing system 1.

The large language model system 2 includes a general-purpose large language model implemented by one or more computers. The large language model system 2 receives an instruction from the information processing system 1, inputs the instruction into the large language model, and passes the obtained output to the information processing system 1. This instruction is in a text format, and is also referred to as “prompt”. In the following description, an instruction in a text format is also referred to as “instruction text”. This general-purpose large language model is trained through use of data from a wide range of fields. The large language model system 2 may be a system which provides a service, for example, ChatGPT (trademark).

The image generation system 3 includes an image generation model implemented by one or more computers. The image generation system 3 receives an instruction from the information processing system 1, inputs the instruction into the image generation model, and passes the obtained output to the information processing system 1. This instruction is in a text format, and is hereinafter also referred to as “instruction text.” The image generation model may be, for example, a machine learning model based on a diffusion model. The image generation system 3 may be a system which provides a service, for example, DALL-E (Registered Trademark) or Stable Diffusion. The image generation system 3 may be started by the same API as that for the large language model system 2.

A simple description of “large language model” given hereinafter refers to the large language model included in the large language model system 2, and a simple description of “image generation model” hereinafter refers to the image generation model included in the image generation system 3. The large language model system 2 may be provided in the information processing system 1. In the at least one embodiment, the information processing system 1 inputs to the large language model a direction (an instruction) which causes the large language model to generate certain information, and acquires output of the large language model as this information. The input of the direction which causes this information to be generated to the large language model is hereinafter also referred to as “directing the large language model to generate the information.”

The information processing system 1 includes one or more computers (for example, server computers). The information processing system 1 includes one or more processors 11, one or more storages 12, and one or more communication units 13. The information processing system 1 may include a plurality of computers each including one or more processors 11, storages 12, and communication units 13, or may include one computer including one or more processors 11 and storages 12. The information processing system 1 may be implemented on one or more virtual servers or container platforms.

Each processor 11 operates based on a program (also referred to as “instruction code”) stored in a storage 12. The processor 11 controls the communication unit 13. The one or more processors 11 include, for example, a central processing unit (CPU), and may further include a graphic processing unit (GPU) and a neural processing unit (NPU). The above-mentioned program may be provided through, for example, the Internet, or may be provided by being stored in a flash memory, a DVD-ROM, or another computer-readable storage medium.

Each storage 12 is formed of a memory device such as a RAM or a flash memory, and an external storage device such as a hard disk drive (HDD) or a solid state drive (SSD). Each storage 12 stores the above-mentioned program. Each storage 12 also stores information and calculation results that are input from the processor 11 and the communication unit 13.

Each communication unit 13 is a communication interface, such as a network interface card, which communicates to and from other devices. The communication unit 13 includes, for example, an integrated circuit which implements a wireless LAN or a wired LAN, an antenna, and a communication terminal. The communication unit 13 inputs information received from another device to the processor 11 and the storage 12 via a network and transmits the information to another device under the control of the processor 11.

The hardware configuration of the information processing system 1 is not limited to the example described above. For example, the information processing system 1 may include a device for reading a computer-readable information storage medium (for example, an optical disc drive or a memory card slot) and a device for inputting and outputting data to and from an external device (for example, a USB port). The external device may be an input device or an output device.

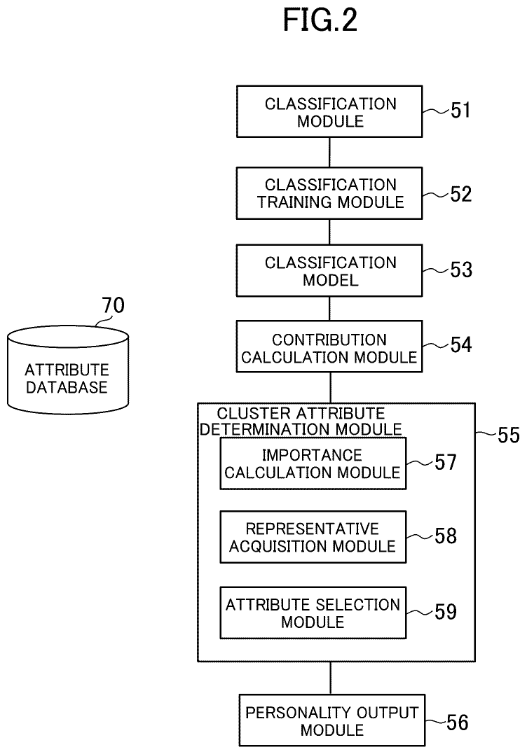

Description is now given of functions provided by the information processing system 1. FIG. 2 is a block diagram for illustrating the functions implemented by the information processing system 1. The information processing system 1 functionally includes a classification module 51, a classification training module 52, a classification model 53, a contribution calculation module cluster attribute determination module 55, a personality output module 56, and an attribute database 70. The cluster attribute determination module 55 functionally includes an importance calculation module 57, a representative acquisition module 58, and an attribute selection module 59. Each of the classification module 51, the classification training module 52, the classification model 53, the contribution calculation module 54, the cluster attribute determination module 55, the personality output module 56, and the attribute database 70 is implemented by the processor 11 executing a program stored in the storage 12 and corresponding to the relevant function, and controlling the communication unit 13 and the like.

The attribute database 70 is a database which stores information (attribute data) on attributes (hereinafter also referred to as “features”) of a plurality of users to be processed by this information processing system 1. The attribute database 70 may be a database which manages information on the attributes in a unified manner. The attribute database 70 may collect attribute information managed by other plurality of systems from those systems, and may store the collected attribute information in the storage 12.

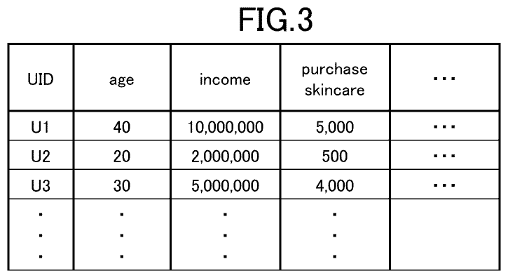

FIG. 3 is a table for showing an example of the data stored in the attribute database 70. The attribute database 70 stores attribute data on each of the plurality of users in association with this user. In FIG. 3, the attribute data stored in the attribute database 70 is shown in a tabular form. In fields “UID,” “age,” “income,” and “purchase_skincare,” values (attribute values) of the attributes of identification information, an age, an income, and a purchase amount of a skincare products of each user are stored, respectively. In FIG. 3, the attribute data is associated with the user through the identification information on the user. In FIG. 3, only the three attributes are shown, but an actual number of attributes may be larger than three.

The classification module 51 classifies the plurality of users into a plurality of clusters based on an attribute value of each of the plurality of types of attributes stored in the attribute database 70 in association with each of the plurality of users.

The classification training module 52 trains the classification model 53 through use of training data including the attribute value of each of the plurality of types of attributes in each of the plurality of users stored in the attribute database 70 and ground truth data indicating the cluster into which each of the plurality of users is classified.

The contribution calculation module 54 calculates, for each of a plurality of users classified into a target cluster being any one of the plurality of clusters, a contribution degree of each of the plurality of types of attributes to the classification into this target cluster. The contribution calculation module 54 may calculate, for each of the plurality of users, a contribution degree to a value of a probability (output of the classification model 53) of belonging to each of the plurality of clusters. In the latter processing, the contribution degree may be calculated also for a user who is not classified into the target cluster.

The contribution calculation module 54 calculates, for each of the plurality of users classified into the target cluster, the contribution degree of each of the plurality of types of attributes to the classification into the target cluster based on the trained classification model 53 and the attribute values of the plurality of types of attributes in each of the plurality of users classified into the target cluster.

The cluster attribute determination module 55 calculates, based on an attribute value of each of a plurality of types of attributes stored in association with each of a plurality of users classified into the target cluster, a representative attribute value representing the target cluster for the attribute of this type. Moreover, the cluster attribute determination module 55 calculates an index value based on the representative attribute value and attribute values in a group formed of a plurality of clusters. The index value indicates whether or not the representative attribute value is very common in the plurality of clusters.

Here, the target cluster is a cluster being a target of processing. The above-mentioned processing may be executed for a plurality of clusters by sequentially specifying each of the plurality of clusters as the target cluster. The same applies to processing described in the following.

The importance calculation module 57 calculates, for each of the plurality of types of attributes, an importance degree for classification of the plurality of users into the target cluster based on the contribution degrees calculated for at least the plurality of users classified into the target cluster. The importance calculation module 57 may calculate, for each of the plurality of types of attributes, an average value of the contribution degrees calculated for at least the plurality of users classified into the target cluster. The average value is calculated as the importance degree. Further, the importance calculation module 57 may calculate, for each of the plurality of types of attributes, a value indicating correlation based on the contribution degrees and the attribute values in the plurality of users classified into the target cluster. The value indicating correlation is calculated as the importance degree.

The representative acquisition module 58 calculates, based on an attribute value of each of a plurality of types of attributes stored in association with each of a plurality of users classified into the target cluster, a representative attribute value representing the target cluster for the attribute of this type. Moreover, the cluster attribute determination module 55 acquires, for each of a plurality of types of attributes expressed as numerical values, as the index value, a relative value indicating a relative relationship between the representative attribute value and an overall representative attribute value which is calculated for a group formed of a plurality of clusters. The cluster attribute determination module 55 acquires, for each of a plurality of types of attributes represented as categories, as the index value, a relative value indicating a probability that a plurality of users classified into a plurality of clusters belong to a category indicated by the representative attribute value of the target cluster.

The representative acquisition module 58 may generate the representative attribute value through the following processing. The representative acquisition module 58 calculates, for each of the plurality of types of attributes, an average value of the contribution degrees calculated for the plurality of users. The representative acquisition module 58 selects some of the plurality of users as one or more representative users based on the average value and the contribution degrees of the plurality of users classified into the target cluster in each of at least some of the plurality of types of attributes. The representative acquisition module 58 generates a representative attribute value that represents the target cluster based on the attribute value in the one or more representative users for the at least some the plurality of types of attributes. The users for which the average of the contribution degrees is to be calculated here may be all of the users or may be the users classified into the target cluster.

The attribute selection module 59 selects some of the plurality of types of attributes based on the importance degree. The attribute selection module 59 may select some of the plurality of types of attributes based on at least one of the importance degree or the index value. Here, the plurality of types of attributes may be classified into a plurality of groups, and the attribute selection module 59 may select, for each group, attributes the number of which is equal to or less than a number determined for this group based on at least one of the importance degree or the index value.

The personality output module 56 outputs, based on the representative attribute value and the importance degree, information indicating representative personality of the users belonging to the target cluster. The importance degree is calculated by the importance calculation module 57 based on the contribution degree. The personality output module 56 more specifically outputs, based on the representative attribute values in the attributes selected based on at least the importance degrees, the information indicating the representative personality of the users belonging to the target cluster. The information indicating the personality includes at least one of a description sentence of the representative user or a generated image of the representative user.

The personality output module 56 inputs, to the large language model, a direction that includes the representative attribute values of at least some (for example, selected attributes) of the plurality of types of attributes for the target cluster and that causes the large language model to generate a sentence indicating the personality, and outputs the information indicating the representative personality of the users belonging to the target cluster based on output of the large language model for this input. The personality output module 56 may input, to the large language model, a direction including the relative values of at least some (for example, the selected attributes) of the plurality of types of attributes, or may input, to the large language model, a direction including the representative attribute values and the relative values thereof.

The personality output module 56 inputs, to the large language model, a direction that is based on the representative attribute value and the contribution degree and that causes the large language model to generate a sentence for generating an image indicating the personality. The personality output module 56 inputs, to the image generation model, a generation direction for an image based on the output of the large language model for the input, and outputs, as the information indicating the representative personality of the users belonging to the target cluster, information including the image that is output from the image generation model.

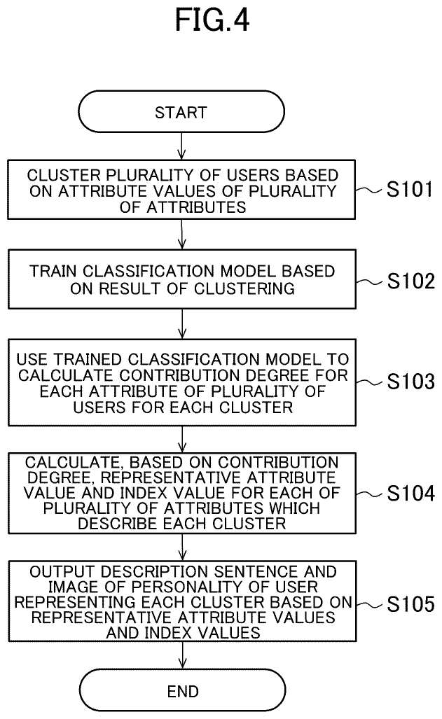

Processing of the information processing system 1 is now described in more detail. FIG. 4 is a flowchart for schematically illustrating the processing of the information processing system 1.

First, the classification module 51 clusters the plurality of users based on the attribute values of the plurality of types of attributes of each of the plurality of users stored in the attribute database 70 (Step S101). The plurality of users are classified into the plurality of clusters by the clustering. A method of the clustering may be, for example, a Gaussian mixture model. The number of clusters may be set in advance by the user, or may be determined by the classification module 51 based on the number of users or the like. The plurality of users may be classified by another publicly-known clustering method.

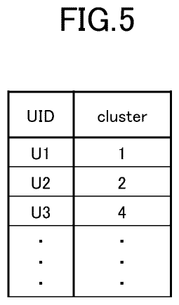

FIG. 5 is a table for showing an example of a result of the clustering. In the example of FIG. 5, fields of “UID” and “cluster” are identification information on the user and identification information on the cluster into which the user is classified, respectively.

The classification training module 52 trains the classification model 53 based on the result of the clustering (Step S102). The training data in this training includes the attribute value of each of the plurality of types of attributes in each of the plurality of users and the ground truth data indicating the cluster into which each of the plurality of users is classified. The classification model 53 is a machine learning model which classifies data through use of a decision tree such as LightGBM. The classification model 53 may be a machine learning model which classifies data based on another method. When the attribute value of each of the plurality of attributes of the user is input, the trained classification model 53 outputs a value indicating a probability that this user belongs to each of the plurality of clusters.

The contribution calculation module 54 uses the trained classification model 53 to calculate, for each cluster, the contribution degree for each of the plurality of attributes of each of the plurality of users (Step S103). Here, the contribution calculation module 54 calculates the contribution degree by a technology of explaining a prediction result of the trained classification model 53.

More specifically, the contribution calculation module 54 calculates, as the contribution degree, a Shapley value (also called “SHAP value”) by a method called “SHapley Additive explanations (SHAP)”. In the SHAP, a method of calculating the Shapley value as a marginal contribution of a player in the game theory is applied to a variation from an average predicted value, to thereby calculate a marginal contribution of a feature. A library for calculating the SHAP is disclosed as an open-source library, and description of details of the calculation is omitted. The Shapley value has such a characteristic that a sum of the Shapley values for all features of a certain user corresponds to a difference between the probability which is output from the classification model 53 and indicates the probability that this user belongs to the cluster and a reference value. The Shapley value is calculated for each combination of the user, the attribute, and the cluster.

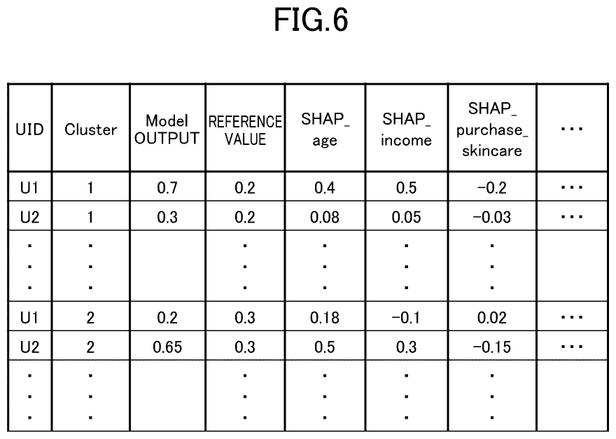

FIG. 6 is a table for showing an example of the calculated contribution degrees. In the example of FIG. 6, fields of “model output,” “reference value,” “SHAP_age,” “SHAP_income,” and “SHAP_purchase_skincare” are a value indicating a probability of classification into a cluster indicated in “Cluster,” a reference value of this value indicating the probability, a contribution degree of the attribute of the age, a contribution degree of the attribute of the income, and a contribution degree of the purchase amount of skincare products, respectively. As can be understood from FIG. 6, the contribution degree is calculated for each combination of the user, the cluster, and the attribute.

The contribution degree may be calculated by a method which is different from that shown in FIG. 6 and which explains the prediction result of the trained classification model 53. Moreover, the contribution degree may be calculated for each combination of the user and the attribute for only the cluster to which the user belongs.

When the contribution degree is calculated, the cluster attribute determination module 55 calculates the representative attribute value and the index value for each of the plurality of attributes describing each cluster (Step S104).

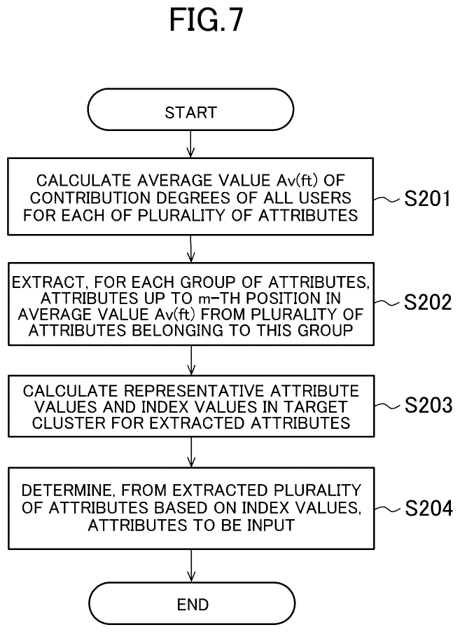

Description is further given of the calculation of the representative attribute value and the index value. FIG. 7 is a flowchart for illustrating an example of processing of the cluster attribute determination module 55. The processing illustrated in FIG. 7 is executed for each cluster. Moreover, the cluster being the target of the processing is written as “target cluster.” The method illustrated in FIG. 7 is referred to as “Top Shapley Approach.”

First, the importance calculation module 57 calculates an average value Av(ft) of the contribution degrees of all of the users for each of the plurality of attributes (Step S201). The symbol ft indicates the attribute being a target of the processing (here, the calculation of the average value). The average value Av(ft) corresponds to an importance degree of the attribute ft for the classification of the plurality of users into the target cluster.

The attribute selection module 59 extracts, for each group of the attributes, attributes up to an m-th position in average value Av(ft) from the plurality of attributes belonging to this group (Step S202). Here, it is assumed that the plurality of types of attributes are classified into the plurality of groups. The plurality of groups may include, for example, at least some of a lifestyle, a life stage, a job, a tendency, finance, a time spendable for using a service, a purchase tendency, and a way of thinking about things. Through the processing step of Step S202, the attribute selection module 59 selects up to “m” attributes for each group. Here, it is assumed that the number “m” of the attributes to be selected is defined for each group. The value of “m” may be, for example, 3 for the group of the lifestyle and 1 for the group of the job.

After that, the representative acquisition module 58 calculates the representative attribute value and the index value in the target cluster for each of the extracted attributes (Step S203).

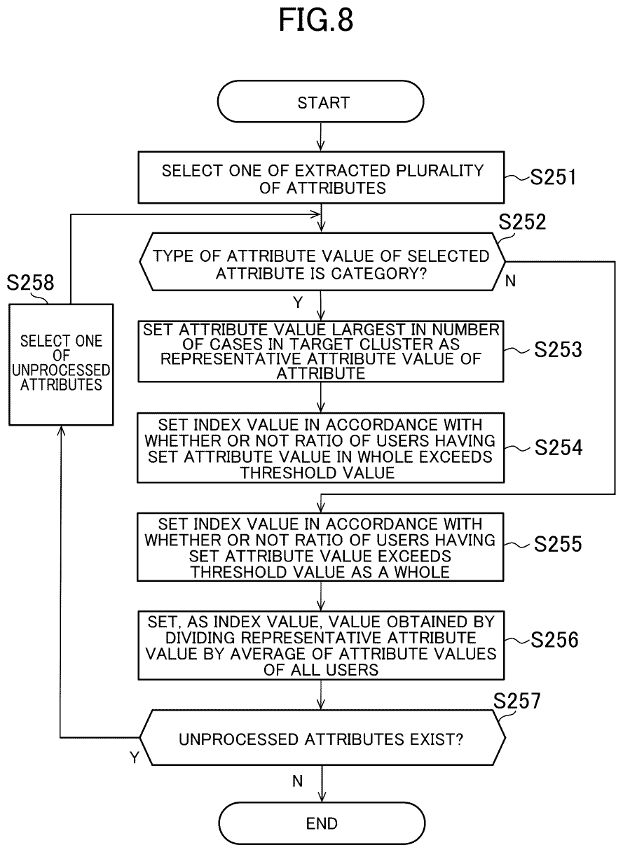

Description is further given of the calculation of the representative attribute value and the index value. FIG. 8 is a flowchart for illustrating an example of processing of calculating the representative attribute values and the index values, and illustrating, in more detail, the processing step of Step S203.

First, the representative acquisition module 58 selects one of the extracted plurality of attributes (Step S251). The representative acquisition module 58 determines whether or not the type of the attribute value of the selected attribute is the category (Step S252).

When the type of the attribute value is the category (Y in Step S252), the representative acquisition module 58 sets, as the representative attribute value of the attribute, the attribute value largest in number of cases in the target cluster (Step S253). After that, the representative acquisition module 58 sets the index value in accordance with whether or not a ratio of the users having the set attribute value in whole exceeds a threshold value (Step S254). Specifically, the representative acquisition module 58 sets 1 as the index value when the ratio of the users having the set attribute value exceeds the threshold value, and sets 0 as the index value otherwise. The ratio of the users having the set attribute value is calculated for all of the users belonging to the clusters including clusters other than the target cluster. Moreover, the threshold value may be a value equal to or larger than 0.5 and smaller than 1.

When the type of the attribute value is a numerical value (N in Step S252), the representative acquisition module 58 sets, as the representative attribute value of the attribute, the average of the attribute values in the target cluster (Step S255). After that, the representative acquisition module 58 sets, as the index value, a value obtained by dividing the representative attribute value by the average of the attribute values of all of the users (Step S256).

When the index value is set, the representative acquisition module 58 determines whether or not unprocessed attributes exist (Step S257). When unprocessed attributes exist (Y in Step S257), the representative acquisition module 58 selects one of the unprocessed attributes (Step S258), and repeats the processing steps of Step S252 and the subsequent steps. When unprocessed attributes do not exist (N in Step S257), the processing of FIG. 8 is finished. Through this loop, the representative attribute value and the index value are calculated for each of the extracted attributes.

When the representative attribute values and the index values are calculated, the attribute selection module 59 determines, based on the index values, the attributes to be input to the large language model from the extracted plurality of attributes (Step S204). The attribute selection module 59 may determine, as the attributes to be input, attributes each having an index value within a predetermined range. The predetermined range may be a range excluding a range of approximately 1. This is because when the index value in a certain attribute is approximately 1, the index value indicates that differences from other clusters are not sufficient in this attribute.

The processing step of Step S204 may be omitted, and the calculated representative attribute values and index values may directly be determined as the data to be input to the large language model. Moreover, in place of the extraction of the attributes in Step S202, the importance degrees to be input to the large language model may be output. A similar effect is provided by directing, on the large language model side, to select attributes having high importance degrees. As a matter of course, quality of the output of the large language model increases by limiting the attributes to be input as in Step S202. The calculation and the use of the index values may be omitted.

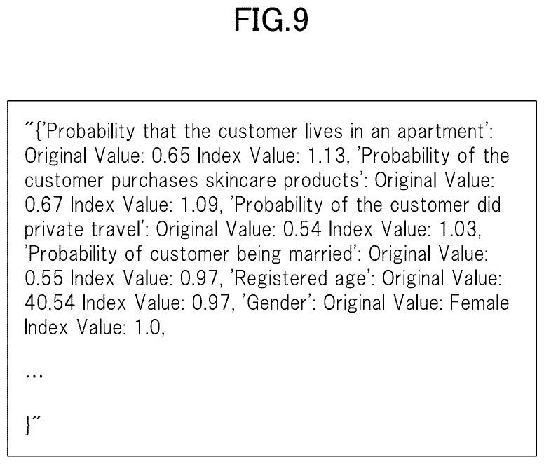

FIG. 9 is a view for illustrating an example of calculated representative attribute values and index values. In FIG. 9, there is illustrated an example of a text in which sets each formed of the attribute name, the representative attribute value, and the index value are listed. “Original Value” is the representative attribute value, and “Index Value” is the index value. In the example of FIG. 9, the representative acquisition module 58 outputs, as the representative attribute value, a category name when the type of the attribute value is the category.

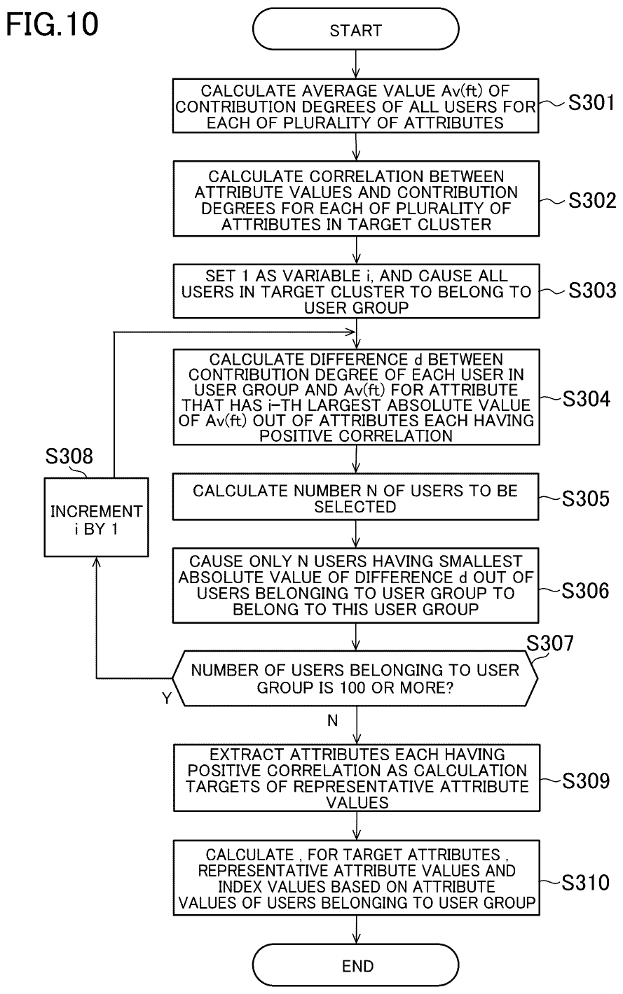

The calculation of the representative attribute value and the index value may be executed by another method. FIG. 10 is a flowchart for illustrating an example of processing of the cluster attribute determination module 55. The processing illustrated in FIG. 10 is executed for each cluster, and the cluster being the target of the processing is written as the target cluster. The method illustrated in FIG. 10 is referred to as “Core Member Approach.”

First, the importance calculation module 57 calculates an average value Av(ft) of the contribution degrees of all of the users for each of the plurality of attributes (Step S301). The users for which the average of the contribution degrees is to be calculated may be the users classified into the target cluster or all of the users including the users in other clusters.

After that, the importance calculation module 57 calculates correlation between the attribute values and the contribution degrees for each of the plurality of attributes in the target cluster (Step S302). The correlation in a certain attribute is a value obtained by summing, for the users included in the target cluster, products each obtained by multiplying the contribution degree and (attribute value-average value) in this attribute. The correlation corresponds to the importance degree of the attribute for the classification of the plurality of users into the target cluster. When the correlation is positive, the correlation indicates that a user having a larger attribute value of this attribute more probably belongs to the cluster.

The representative acquisition module 58 sets 1 as a variable “i,” and causes all the users in the target cluster to belong to a user group (Step S303). The representative acquisition module 58 calculates a difference “d” between the contribution degree of each user in the user group and the average value Av(ft) for an attribute that has an i-th largest absolute value of the average Av(ft) out of the attributes each having a positive correlation (Step S304). Moreover, the representative acquisition module 58 calculates a number N of users to be selected (Step S305). The number N of users is calculated by truncating a fractional part of a quotient of division of the number of users belonging to the current user group by the absolute value of the average Av(ft).

The representative acquisition module 58 causes users who are up to the N-th position in the absolute value of the difference “d” out of the users who belong to the user group to belong to a new user group (Step S306). When the number of users who belong to this new user group is 100 or more (Y in Step S307), the representative acquisition module 58 increments “i” by 1 (Step S308), and repeats the processing steps of Step S304 and the subsequent steps for the new user group.

Meanwhile, when the number of users who belong to the user group is less than 100 (N in Step S307), the attribute selection module 59 extracts attributes each having a positive correlation as the calculation targets for the representative attribute values (Step S309), and the representative acquisition module 58 calculates, for the attributes of the calculation target, the representative attribute values and the index values based on the attribute values of the users belonging to the user group (Step S310). In FIG. 8, the representative attribute values and the index values may be calculated through use of, in place of the attribute values of the users included in the target cluster, the attribute values of the users belonging to the user group. After the processing step of Step S310, the attribute selection module 59 may execute the processing step of Step S204, that is, may limit the attributes based on the index values.

In the method illustrated in FIG. 10, the correlation is calculated as the importance degree based on the contribution degrees, and the attributes to be input to the large language model are limited through this correlation. In the method illustrated in FIG. 7 as well, the correlation may be used as the importance degree to limit the attributes. Moreover, in the method illustrated in FIG. 10, the representative attribute value is calculated from, instead of the attribute values of all of the users included in the target cluster, the attribute values of one or more users who have similar contribution degrees in the important attributes out of the users included in the target cluster. As a result, noise of the users belonging to the cluster is reduced, and the representative attribute value is calculated from the users high in characteristic of the cluster.

When the representative attribute values and the index values to be input to the large language model are determined in Step S104, the personality output module 56 outputs the description sentence and the image of the personality of the user representing each cluster based on those representative attribute values and index values (Step S105). The large language model is used for the generation of the description sentence, and the image generation model is used for the generation of the image.

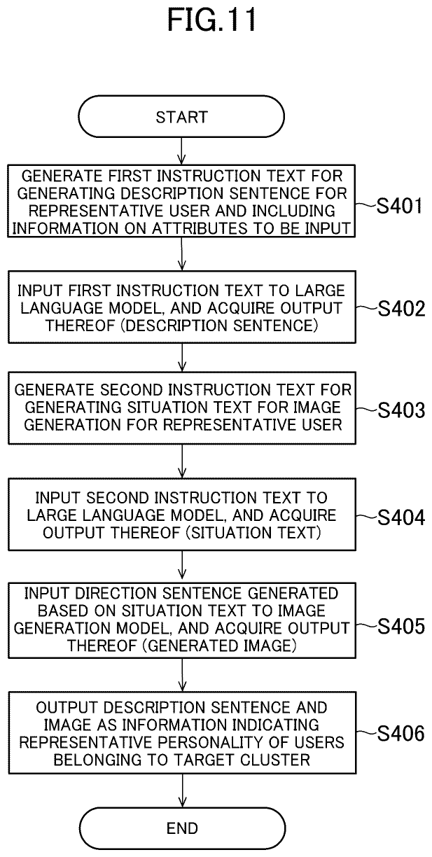

Description is now given of details of the processing step of Step S105. FIG. 11 is a flowchart for illustrating an example of the processing of the personality output module 56.

First, the personality output module 56 generates a first instruction text for causing a large language model to generate the description sentence for the representative user (Step S401). The first instruction text is a prompt to be input to the large language model, and includes an instruction sentence and information on the attribute to be input. When a large language model specialized in the generation of the description sentence is used, it is not required to include the instruction sentence. The information on the attributes to be input includes at least one of the representative attribute value or the index value. After that, the first instruction text is input to the large language model, and output (description sentence) of the large language model is acquired (Step S402).

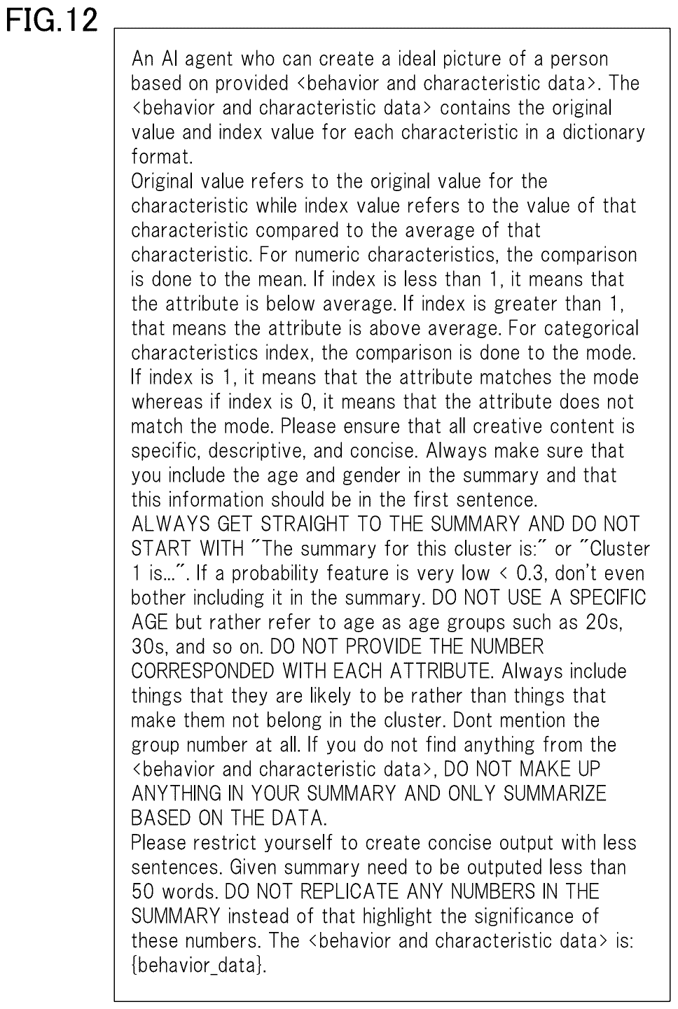

FIG. 12 is a view for illustrating an example of the first instruction text. In FIG. 12, a template of the first instruction text is illustrated in a strict sense, and a portion of {behavior_data} is replaced by a text in which sets each formed of the attribute name, the representative attribute value, and the index value as illustrated in FIG. 9 are listed. In FIG. 12, the first instruction text is written in English, but may be written in another language. A language in examples of the text input to the large language model and the image generation model and the text output from the large language model, which are described below, may also be different. Moreover, the first instruction text is not required to include the index value.

In the example of FIG. 12, the first instruction text includes texts which describe the representative attribute value and the index value and texts which specify a form of the description sentence to be output. More specifically, the first instruction text includes a direction to output an age group in place of the age itself, a direction to avoid output of internal information such as the cluster, and a direction to avoid use of an attribute for the generation of the description sentence when the attribute has a low attribute value indicating the probability.

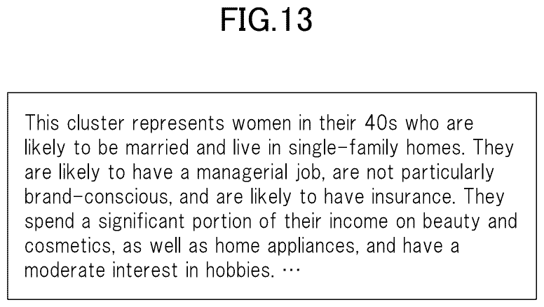

FIG. 13 is a view for illustrating an example of the description sentence generated based on the first instruction text. In FIG. 13, the description sentence is output in English, but the personality output module 56 may adjust the first instruction text, to thereby cause the description sentence to be output in another language.

When the description sentence is acquired, the personality output module 56 generates a second instruction text for causing the large language model to generate a situation text for the image generation for the representative user (Step S403).

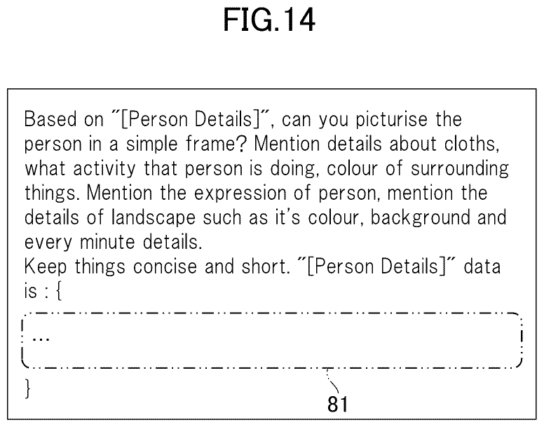

FIG. 14 is a view for illustrating an example of the second instruction text. In a region 81, the description sentence as illustrated in FIG. 13 is actually set. In the generation of the image, it is better to specify a detailed scene, and accuracy of the image is not required much compared with that of the description sentence. Thus, the second instruction text includes, in the situation text, a direction to output clothing, a color, a background, and the like which can be associated with the description sentence.

Here, the second instruction text may include an instruction to generate the situation text from the description sentence, or an instruction to generate the situation text directly from at least one of the representative attribute value or the index value. Moreover, the situation text may be generated on a plurality of separate stages. For example, on a first stage, the personality output module 56 may direct the large language model to generate, from the representative attribute value and the index value, a text which is different from the description sentence and indicates the personality representing the user. On a second stage, the personality output module 56 may direct the large language model to generate the situation text from the generated text.

When the second instruction text is generated, the personality output module 56 inputs the second instruction text to the large language model, and acquires the output (situation text) of the large language model (Step S404). The personality output module 56 generates a direction sentence based on the situation text. The personality output module 56 inputs this direction sentence to the image generation model, and acquires the output (generated image) of the image generation model (Step S405).

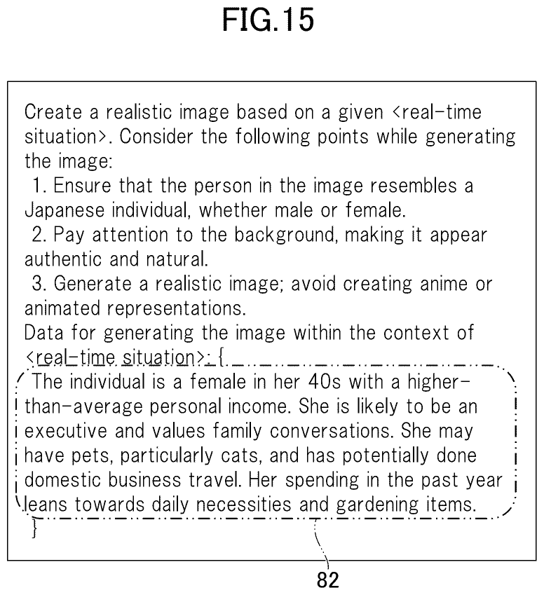

FIG. 15 is a view for illustrating an example of the direction sentence generated based on the second instruction text. In a region 82, the situation text is embedded.

After that, the personality output module 56 outputs, to the administrator, the description sentence and the image as the information indicating the representative personality of the users belonging to the target cluster (Step S406).

Through the processing illustrated in FIG. 10, the description sentence and the image describing the representative user of the cluster are generated from the statistical data such as the representative attribute value, and are output to the administrator. Here, the personality output module 56 is not always required to use the large language model or the image generation model. For example, the personality output module 56 may simply output, to the administrator, a list of the representative attribute values and the index values of the selected attributes.

Hitherto, analysis of users, in particular, segmentation, that uses big data has relied on the intuition of the administrator. The information processing system 1 according to the at least one embodiment can find the cluster of the users from various attributes indicating the features of the users. Moreover, the information processing system 1 uses the contribution degrees of the attributes based on the explainable AI technology to analyze the result of the clustering, thereby being able to detect the attributes which characterize the cluster. The information processing system 1 can use the attribute to acquire and then output the information indicating the personality of the representative user included in the cluster.

In the at least one embodiment, a large language model is used, but there are no particular limitations on the implementation of the language model or the scale of the number of parameters. The present invention is applicable to machine learning models (language models) which handle natural language.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An information processing system, comprising:
at least one processor; and
at least one memory device that stores a plurality of instructions which, when executed by the at least one processor, causes the at least one processor to:
classify, based on an attribute value of each of a plurality of types of attributes stored in association with each of a plurality of users, the plurality of users into a plurality of clusters;
calculate, for each of a plurality of users classified into a target cluster being any one of the plurality of clusters, a contribution degree of each of the plurality of types of attributes to classify into the target cluster;
acquire, based on the attribute value of each of the plurality of types of attributes stored in association with each of the plurality of users classified into the target cluster, a representative attribute value that represents the target cluster corresponding to one of the plurality of types of attributes; and
output, based on the representative attribute value and the contribution degree, information indicating a representative personality of a user belonging to the target cluster.

2. The information processing system according to claim 1, wherein the plurality of instructions cause the at least one processor to train a machine learning model through use of training data including the attribute value of each of the plurality of types of attributes in each of the plurality of users and ground truth data indicating a cluster into which each of the plurality of users is classified,
wherein the contribution degree of each of the plurality of types of attributes to the classification into the target cluster is calculated for each of the plurality of users classified into the target cluster based on the trained machine learning model and the attribute values of the plurality of types of attributes in each of the plurality of users classified into the target cluster.

3. The information processing system according to claim 1, wherein the plurality of instructions cause the at least one processor the to calculate an importance degree for classification of the plurality of users into the target cluster for each of the plurality of types of attributes based on the contribution degrees calculated for the plurality of users classified into the target cluster,
wherein the information indicating the representative personality of a user belonging to the target cluster is output based on the representative attribute value and the importance degree.

4. The information processing system according to claim 3, wherein the plurality of instructions cause the at least one processor to select some of the plurality of types of attributes based on the importance degree,
wherein the information indicating the representative personality of the plurality of users belonging to the target cluster is output based on the representative attribute values in the selected some of the plurality of types of attributes.

5. The information processing system according to claim 3, wherein the plurality of instructions cause the at least one processor to calculate, as the importance degree, an average value of the contribution degrees calculated for the plurality of users classified into the target cluster for each of the plurality of types of attributes.

6. The information processing system according to claim 3, wherein the plurality of instructions cause the at least one processor to calculate, as the importance degree, a value indicating a correlation based on the contribution degrees and the attribute values in the plurality of users classified into the target cluster for each of the plurality of types of attributes.

7. The information processing system according to claim 3, wherein the plurality of instructions cause the at least one processor to:
calculate an average value of the contribution degrees calculated for the plurality of users for each of the plurality of types of attributes;
select some of the plurality of users as one or more representative users based on the average value and the contribution degrees of the plurality of users classified into the target cluster in each of at least some of the plurality of types of attributes; and
generate a representative attribute value that represents the target cluster based on the attribute value in the one or more representative users for the at least some of the plurality of types of attributes.

8. The information processing system according to claim 1,
wherein the plurality of instructions cause the at least one processor to acquire a relative value that indicates a relative relationship between each of the representative attribute values calculated for the plurality of types of attributes and an overall representative attribute value calculated for a group formed of the plurality of clusters, and
wherein the information indicating the representative personality of a user belonging to the target cluster is output based on the contribution degree, the acquired relative value, and the representative attribute value.

9. The information processing system according to claim 8, wherein the plurality of instructions cause the at least one processor to acquire, for an attribute that indicates a category out of the plurality of types of attributes, a relative value indicating a probability that a plurality of users classified into the plurality of clusters belong to a category indicated by the representative attribute value of the target cluster.

10. The information processing system according to claim 8, wherein the information indicating the representative personality of a user belonging to the target cluster is output based on the representative attribute value in an attribute selected from the plurality of types of attributes based on the contribution degree and the acquired relative value.

11. The information processing system according to claim 1, wherein the plurality of instructions cause the at least one processor to input, to a language model, a direction that includes the representative attribute values of at least some of the plurality of types of attributes for the target cluster and that causes the language model to generate a sentence indicating personality, and output the information indicating the representative personality of a user belonging to the target cluster based on output of the language model for the input.

12. The information processing system according to claim 11, wherein the plurality of instructions cause the at least one processor to select some of the plurality of types of attributes based on the contribution degree,
wherein the plurality of instructions cause the at least one processor to input, to a language model, a direction that includes the representative attribute values of the selected some of the plurality of types of attributes and that causes the language model to generate a sentence indicating personality, and output the information indicating the representative personality of the plurality of users belonging to the target cluster based on output of the language model for the input.

13. The information processing system according to claim 8, wherein the plurality of instructions cause the at least one processor to input, to a language model, a direction that includes the relative values of at least some of the plurality of types of attributes for the target cluster and that causes the language model to generate a sentence indicating personality, and output the information indicating the representative personality of a user belonging to the target cluster based on output of the language model for the input.

14. The information processing system according to claim 1, wherein the plurality of instructions cause the at least one processor to:
input, to a language model, a direction that is based on the representative attribute value and the contribution degree and that causes the language model to generate a sentence for generating an image indicating personality; and
input, to an image generation model, a generation direction for an image based on output of the language model for the input, and output, as the information indicating the representative personality of a user belonging to the target cluster, information including the image that is output from the image generation model.

15. An information processing method, comprising:
classifying, based on an attribute value of each of a plurality of types of attributes stored in association with each of a plurality of users, the plurality of users into a plurality of clusters with at least one processor operating with a memory device in a system;
calculating, for each of a plurality of users classified into a target cluster being any one of the plurality of clusters, a contribution degree of each of the plurality of types of attributes to classify into the target cluster with the at least one processor operating with the memory device in the system;
acquiring, based on the attribute value of each of the plurality of types of attributes stored in association with each of the plurality of users classified into the target cluster, a representative attribute value that represents the target cluster corresponding to one of the plurality of types of attributes with the at least one processor operating with the memory device in the system; and
outputting, based on the representative attribute value and the contribution degree, information indicating a representative personality of a user belonging to the target cluster with the at least one processor operating with the memory device in the system.

16. A non-transitory computer readable storage medium storing a plurality of instructions, wherein when executed by at least one processor, the plurality of instructions cause the at least one processor to:
classify, based on an attribute value of each of a plurality of types of attributes stored in association with each of a plurality of users, the plurality of users into a plurality of clusters;
calculate, for each of a plurality of users classified into a target cluster being any one of the plurality of clusters, a contribution degree of each of the plurality of types of attributes to classify into the target cluster;
acquire, based on the attribute value of each of the plurality of types of attributes stored in association with each of the plurality of users classified into the target cluster, a representative attribute value that represents the target cluster corresponding to one of the plurality of types of attributes; and
output, based on the representative attribute value and the contribution degree, information indicating a representative personality of a user belonging to the target cluster.
